(19) United States
(12) Patent Application Publication
(10) Pub. No.: US 2025/0293443 A1
(43) Pub. Date: Sep. 18, 2025

(54) ELECTRICAL CONNECTION TOOL ENSURING OPTIMUM CURRENT FLOW BY CLAMPING THE CORE OF A WIRE TO BE CONNECTED

(71) Applicant: CREATIQUE TECHNOLOGIE, Billy-Berclau (FR)

(72) Inventor: Stéphane VASSEUR, Gourdon (FR)

(21) Appl. No.: 18/862,757

(22) PCT Filed: May 12, 2023
(86) PCT No.: PCT/EP2023/062755

§ 371 Date: Nov. 4, 2024

(30) Foreign Application Priority Data
May 13, 2022 (FR) FR2204579
Nov. 8, 2022 (FR) FR2211596

(51) Int. Cl. H01R 4/46; H01M 10/42; H01R 11/16

(52) U.S. Cl. CPC H01R 4/46; H01M 10/4285; H01R 11/16

(57) ABSTRACT

The present invention relates to an electrical connection tool ensuring current flow by clamping the core of a wire to be connected. The tool includes a body extending according to a first axis and provided with a conductive element. The body has a first recess for receiving the core. The tool further includes means for clamping the wire. The first recess defining a second axis oriented according to an acute angle with respect to said first axis.

### TECHNICAL FIELD

The present invention relates to the field of industrial electrical tooling.

More particularly, the object of the present invention relates to a device allowing creating a reliable, easily maintainable and compact electrical connection for high-current levels, between an electrical wire and a conductive element.

In the context of the present invention, by “conductive element”, it should be understood herein and throughout the following description an element dedicated for the conduction of an electric current, the specific design of which varies depending on the type of connection to be made. Thus, the conductive element corresponds, for example, to an element of a power supply connector, in particular of a male or female electrical socket, or to an electrical conductor of a connection terminal or of a connection strip.

Furthermore, in the context of the present invention, by “high current”, it should be understood herein and throughout the following description a current suitable for industrial processes, for example a current suitable for battery cell tests, or any other operation, in particular a current close—on the date of the invention—to 300 A.

### PRIOR ART

It is known to make a high-current electrical connection with several solutions in the prior art.

A first solution illustrated in [FIG. 1] appended to the present description consists in making the electrical connection using a cable lug 1A crimped onto the wire to be connected and held in position by a clamping nut 2A on the conductive element 3A.

One of the drawbacks of such a solution is that the cable lug 1A is crimped onto the wire to be connected.

To crimp this cable lug 1A, a specific crimping clamp should be used for each available wire section.

In case of wire replacement, the operator on site should be equipped with this clamp suited for crimping the cable lugs 1A on the wire or have available wires with suitable lengths and equipped with crimped cable lugs. The Applicant observes that this considerably increases the number of references to be kept in stock for maintenance operations, which is not conceivable in practice.

One of the other drawbacks of this solution is that the cable lug 1A has a long rigid portion to allow crimping the wire. This rigid portion extends perpendicularly with respect to the conductive element 3A. This rigid portion may be a problem for reducing the space between two conductive elements 3A and different electrical potentials, since it becomes impossible to position two adjacent conductive elements 3A according to the direction in which the cable lug 1A extends, without the cable lug 1A and/or the crimped wire colliding with an adjacent conductive element.

A second solution illustrated in [FIG. 2] appended to the present description consists in making the connection using a system 2B for axially clamping the core of the wire.

The system 2B is in the form of a hollow cylindrical part having two openings. The core of the wire 3B is inserted into a first opening, then the conductive element 1B is inserted into the second opening and assembled with the system 2B, for example by screwing using an external thread of the conductive element 1B and an internal thread of the system 2B. The end of the conductive element 1B, for example a conical end, then clamps and deforms the core of the wire 3B against the inner wall of the system 2B.

One of the drawbacks of this system is that the connection between the conductive element 1B and the wire 3B is necessarily coaxial. Such a design poses problems for routing wires with large sections in a space that is reduced in depth because the wire should comply with a minimum radius of curvature to preserve its integrity. In other words, the wire 3B extends coaxially with the conductive element 1B, and cannot be reoriented in other directions without complying with its minimum radius of curvature. This results in a considerable lengthwise bulk, defined by the radius of curvature of the wire 3B, in particular when making high-current connections requiring wires with a large diameter, which are associated with large radii of curvature.

The Applicant observes that the aforementioned solutions allow guaranteeing the flow of high currents corresponding to the section of the conductive element and that of the wire to be connected but pose bulk and/or maintenance problems.

For these reasons, the Applicant considers that the solutions of the prior art are not fully satisfactory because they are not suited to the existing environment and to the constraints of industrial operations for high current flow.

### SUBJECT MATTER OF THE INVENTION

The present invention aims to improve the above-described situation.

One of the objectives of the present invention is to overcome the different aforementioned drawbacks by proposing the design of an electrical connection tool guaranteeing an optimum current flow by simply clamping the core of the wire to be connected.

Another objective of the present invention is to provide an electrical connection tool suited to the dimensional constraints of high-current operations.

To this end, an object of the present invention relates, according to a first aspect, to an electrical connection tool ensuring current flow by clamping a core of a wire, the tool comprising a body extending according to a longitudinal direction defining a first axis, the body being provided with a conductive element, the body having a first recess sized for receiving the core of the wire, the tool further comprising means for clamping the wire with the body, the tool being configured to ensure current flow between the conductive element and the core of the wire when the core is received by the first recess.

It should herein be understood that the current flow is performed so as to make the electrical connection between a wire and a conductive element, for example by bringing the wire and the conductive element into direct contact, or via constituent elements of the tool, for example via the body receiving the wire and the conductive element.

It should be further understood that the integration of the conductive element into the connection tool depends on the design of the conductive element, the conductive element for example protruding with respect to the body or defining a cavity of the body. Of course, the body is provided with the conductive element so that the conductive element is accessible for connection thereof with an auxiliary part, for example with a plug or a socket.

Advantageously, the first recess defines a second axis for receiving the core, the second axis being oriented according to an acute angle with respect to the first axis.

It should herein be understood that the second axis of reception of the core corresponds to the axis according to which the wire is inserted and held in the first recess. Thus, the orientation of the second axis is defined by the structure of the first recess. For example, the first recess has a cylindrical cavity shape, the second axis corresponding to the axis of revolution of the cavity.

In the context of the present invention, by “acute angle”, it should be understood herein and throughout the following description a non-zero angle between the second axis and the first axis, the extent of which in degrees is less than 90°. Of course, such an acute angle should be differentiated from a clearance or a design tolerance in a coaxial or perpendicular assembly.

In other words, the wire is received by the electrical connection tool according to a second axis which is not coaxial and not perpendicular to the longitudinal direction of the connection tool, allowing at least partially reorienting the wire with respect to the longitudinal direction as soon as it is assembled with the electrical connection tool. The direction of the wire is already at least partially suited to a non-longitudinal configuration, and the lengthwise bulk resulting from the radius of curvature of the wire is reduced. Furthermore, the extension of the wire at a non-perpendicular angle allows arranging a plurality of adjacent connection tools, for example according to a grid-fashion shape and in particular inside an electrical interface, without the wires colliding with the adjacent tools.

Thanks to the present invention, the electrical connection tool enables the design of electronic assemblies, for example connection interfaces, which minimize the bulk associated with wiring and are suited to compact, non-longitudinal structures involving high currents.

In an advantageous embodiment of the present invention, the body defines two opposite longitudinal ends, the conductive element being arranged according to a first longitudinal end and the first recess being arranged according to a second longitudinal end.

It should herein be understood that the conductive element and the first recess are arranged on either side of the body according to the first axis, in particular so as to ensure that the reception of the wire by the first recess does not hinder the accessibility of the conductive element. This design also allows facilitating the integration of the tool into a connection interface by arranging the tool so that the first axis is perpendicular to a plane of the connection interface, resulting in a conductive element accessible according to a first face of the interface, the reception of the wire by the first recess being performed according to an opposite second face of the interface. Of course, the first recess being oriented according to the second axis, it should herein be understood that this design is not restricted to a first recess forming the second longitudinal end but, on the contrary, to a first recess formed according to a portion of the body forming the second longitudinal end.

In a specific embodiment, the clamping means comprise a clamp associated with at least one screw.

It should herein be understood that the clamp corresponds to a substantially planar mechanical part associated with the body so as to clamp the core of the wire, the clamping being carried out by screwing the clamp against the body, the clamp vising the core with the body.

Preferably, the body has a second recess opening into the first recess, the second recess being sized for receiving the clamp.

It should herein be understood that the clamp is inserted into the second recess, after insertion of the wire into the first recess, so as to place the clamp directly in contact with the core of the wire for clamping thereof, without deforming the body during clamping.

In a further embodiment, the tool further includes a bushing made of an insulating material covering the body radially with respect to the first axis, the tool further comprising means for holding the bushing in position according to the first axis.

It should herein be understood that the bushing forms an insulating outer enclosure of the tool, enabling handling and/or integration thereof into a wider device without making any faulty contact and without any risk. In particular, the other elements of the tool, in particular the body, may be made of conductive materials allowing ensuring current flow between the wire and the conductive element, while controlling this current flow.

Of course, the bushing is sized so as not to obstruct the first recess and to keep the conductive element accessible. For example, the bushing extends over a limited length in the longitudinal direction, so as to integrate the tool into a planar interface perpendicular to the longitudinal direction, while limiting the bulk of the tool. The means for holding in position then allow holding the sleeve around the body and at the same time holding the body longitudinally with respect to the interface.

Preferably, the bushing includes two portions configured to interlock into one another by sliding according to the first axis.

A person skilled in the art should understand that this design allows assembling the connection tool in an orifice with dimensions smaller than those of the bushing, for example an orifice of an electrical interface, the two portions of the bushing being positioned in a vise with respect to the orifice in order to make an insulating and stable assembly of the tool with the interface.

In a further embodiment, the position holding means comprise at least one elastic ring arranged adjacent to the bushing according to the first axis.

It should herein be understood that the elastic ring blocks the longitudinal movement of the bushing according to the first axis, the elastic nature of the ring allowing setting the ring aside in order to arrange it around the body, the ring automatically clamping around the body once it has been released and opposing any translation according to the first axis. For example, a pair of elastic rings is provided for arranged on either side of the bushing so as to block any movement of the bushing along the first axis.

In a particular embodiment, the conductive element corresponds to a female connector.

It should herein be understood that the conductive element forms at least partially a port enabling the connection of a plug or socket, so as to establish an electrical connection of the wire towards the male socket via the connection tool.

In still another embodiment, the second axis is oriented according to an angle comprised between 10° and 80° with respect to the first axis.

Preferably, the second axis is oriented according to an angle comprised between 30° and 60° with respect to the first axis.

It should herein be understood that the selection of the angle is performed according to the design constraints, in particular of the electrical equipment with which the connection tool is associated and to the desired configuration of the internal or external cabling. the equipment. It should also be understood that a smaller angle allows limiting the depth bulk, whereas a larger angle allows positioning two tools closer to one another without collision.

In another embodiment, the tool is sized so as to ensure the flow of a current of at least 300 A.

It should herein be understood that the tool is suited to the flow of high currents, in particular that the tool is sized in a joint manner on demand in terms of current flow through an industrial equipment, which corresponds, on the date of the invention, to a current close to 300 A. For example, the tool is capacitive for a value ranging up to 500 A. It should also be understood that the sizing of the tool comprises in particular the sizing of the first recess, a high amperage being associated with a wire with a larger diameter. For example, the first recess is sized so as to enable the insertion of a core with a diameter of at least 70 mm², associated with a current of at least 300 A, without causing crushing of the core.

A second aspect of the present invention relates to an electrical connection interface, the interface comprising a first face and a second face, the interface comprising at least one electrical connection tool according to the first aspect of the invention, the first recess of the tool being arranged according to the first face and the conductive element being arranged according to the second face.

It should herein be understood that the connection interface corresponds to a part allowing arranging one or more connector(s), generally a set of connectors, so that each connector is accessible and enables the reception of a dedicated plug or socket for establishing an electrical connection, the interface being associated with a device, the set of connectors enabling the supply of the device with power or the power supply by the device or the transmission of data with the device. Thus, the connection tool is arranged so as to pass through the connection interface, so that the first recess and the conductive element are arranged according to opposite faces of the connection interface.

For example, the connection interface is arranged according to a facade of a device and allows performing a connection between an inner portion of the device and an outer portion of the device.

In this design, the first recess of the tool is for example arranged according to a first face in the inner portion of the device, the first recess receiving a wire of the internal wiring of the device.

Thus, the orientation of the first recess according to the second axis allows adapting the device of the internal cabling to the geometry of the device, and in particular reducing its dimensional constraints.

In one implementation, the first recess of the tool is free to rotate relative to the first axis.

A person skilled in the art should understand that this design allows adapting the orientation of the first recess according to a cone defined by the rotation of the second axis according to the first axis. This design allows rapidly adapting the position of the first recess, and therefore the orientation of the wire, according to the geometry desired for the installation of the interface. For example, the rotation of the first recess corresponds to a rotation of the first recess relative to the body, or to a rotation of the connection tool relative to the interface.

It should also be understood that the minimum radius of curvature of the wire defines a cone of positions that could be reached by a wire with given length and diameter according to the orientation of the second axis according to which the wire is inserted into the first recess. Thus, the angle between the first axis and the second axis allows, on the one hand, offsetting the cone of positions, whereas a rotation of the first recess about the first axis, before or after assembly of the tool with the interface, allows defining a plurality of cone of positions, considerably increasing, in accordance with the invention, the possibilities of geometry compatible with a wire clamped by the electrical connection tool.

A third aspect of the present invention relates to an electric panel comprising at least one electrical connection interface according to the second aspect of the present invention.

It should herein be understood that the electrical panel comprises one or more connection interface(s) incorporating at least one electrical connection tool. For example, the electric panel comprises a plurality of connection terminals each comprising at least one electrical connection tool, and is for example integrated inside an electrical cabinet.

A fourth aspect of the present invention relates to a test bench for a battery cell, the bench comprising at least one electrical connection interface according to the second aspect of the present invention.

A test bench herein corresponds to a device configured for the completion of testing, forming, proofing, production, control, ageing or end-of-life management phases, of one or more electric battery cell(s). It should herein be understood that the completion of either one of these phases requires the flow of high currents so as to test the performances of the battery cell under real conditions, in particular for vehicle battery cells. Thus, the connection interface comprising the connection tool according to the first aspect of the invention may be integrated into a test bench, in particular inside a production line, according to a compact design and suited to substantial wiring with a large diameter.

Of course, the electrical tool and the electrical interface receiving the tool according to the invention can be integrated into a plurality of electrical devices, in particular industrial devices requiring the flow of high currents.

Thus, through the different functional and structural features hereinabove, the Applicant proposes an electrical connection tool enabling the reception of the core of a wire so as to establish a current flow, the connection tool being suited for integration thereof into compact designs by reorienting the wire so as to minimize the impact of its radius of curvature. The Applicant also proposes an electrical connection interface integrating such a connection tool, as well as a plurality of devices implementing the electrical connection interface.

### DESCRIPTION OF THE FIGURES

Other features and advantages of the present invention will appear from the description hereinbelow, with reference to the appended figures which illustrate a plurality of embodiments which are in no way limiting and wherein:

FIG. 1 is an example of a high-current electrical connection according to the known prior art;

FIG. 3 is another example of a high-current connection according to the known prior art;

FIG. 3 schematically shows a perspective view of two electrical connection tools receiving a wire according to an embodiment of the present invention;

FIG. 4 schematically shows a front view of a tool in accordance with FIG. 3;

FIG. 5 shows an exploded view of a tool in accordance with FIG. 3;

FIG. 6 shows a first face of a first electrical connection interface receiving a plurality of tools in accordance with FIG. 3; and

FIG. 7 shows a second face of a second electrical connection interface receiving a plurality of tools in accordance with FIG. 3.

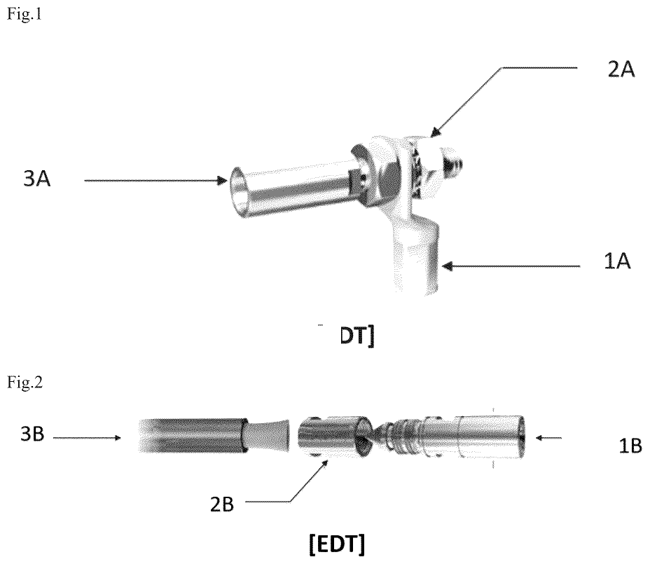

### DETAILED DESCRIPTION

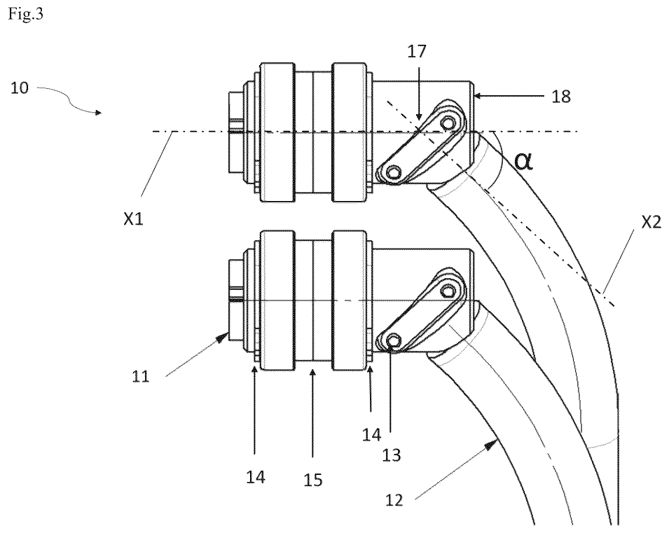

An electrical connection tool guaranteeing an optimum current flow by simply clamping the core of the wire to be connected according to an embodiment of the present invention, as well as an electrical connection interface integrating such a tool, will now be described with reference to FIGS. 3 to 7 together.

It should be reminded that one of the objectives of the present invention consists in enabling the reception of a wire by an electrical connection system so as to:
reduce the depth bulk; and
preserve the possibility of aligning several identical systems without them interfering with each other, like for example in a connector with several power channels.

This is made possible in the example described hereinafter.

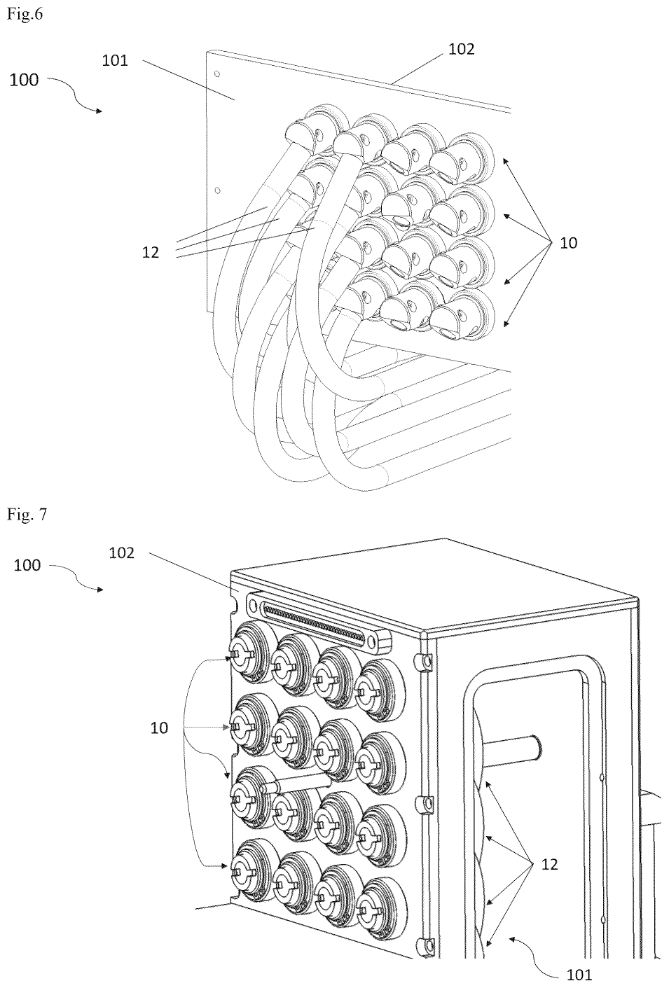

According to the example of FIGS. 6 and 7, it is herein provided for an electrical connection interface 100, for example an interface 100 of an interconnection module configured to connect several industrial electrical devices. In this example, the connection interface 100 is configured to receive sixteen high-current connectors, sized for a 300A current. Thus, the interface 100 receives sixteen electrical connection tools 10 according to the invention, each tool 10 forming a connector.

Of course, It should be understood that the invention also applies to connection interfaces 100 of various electrical devices, for example an electric panel or more generally an interface 100 of an industrial electrical apparatus. According to the example of FIG. 7, the interface 100 receives, for example, a set of contacts for low currents, juxtaposed with the sixteen tools 10.

According to this example, the interface 100 has a first face 101 and a second face 102 opposite to the first face 101. For example, as illustrated in FIG. 7, the first face 101 corresponds to an inner face of the considered device (herein the interconnection module), and the second face 102 to an outer face of the device. Thus, for example, the interface 100 has according to its second face 102 sixteen female contacts capable of letting 300A pass continuously, and sixteen wires 12 according to its first face 101, each female contact corresponding to a tool 10 associated with a wire 12.

In this example, to make such an intensity pass, each contact should be connected to a wire 12 with a 70 mm² section. A range suited to different wire 12 sections is considered in order to address different current demands. It should herein be understood that the section of the wire 12 varies according to the current for which it is sized.

A problem that arises, in particular for a wire 12 with a large section, is the radius of curvature associated with the wire 12. Indeed, depending on the design of the interface 100 and the device into which it is integrated, the space available for the wire(s) 12 is restricted, in particular when the interface 100 is integrated into an industrial device, for example inside a production line, and when the wires 12 are used to connect non-coaxial elements.

In order to overcome this problem, an electrical connection tool 10 is provided for allowing facilitating the integration of a wire 12 according to a constraining geometry.

As illustrated in FIGS. 3 to 5, the electrical connection tool 10 according to the invention comprises a body 18 extending in a longitudinal direction defining a first axis X1, for example a body 18 with a substantially cylindrical shape. Advantageously, the body 18 is provided with a conductive element 11. According to the example of FIG. 5, the conductive element 11 is arranged inside the body 18 and also has a substantially cylindrical shape.

In particular, the conductive element 11 is integrated into the body 18 so as to be arranged according to the second face 102 when the tool 10 is assembled on the interface 100, according to the example of FIG. 7. For example, the conductive element 11 is arranged according to a first longitudinal end of the body 18 and slightly protruding with respect to the body 18, so as to extend from the tool 10 and to be accessible on the second face 102. Of course, the exact shape of the conductive element 11 is designed according to the connection to be made, i.e. the type of connector expected on the tool 10 and/or on the interface 100. In this case, the conductive element 11 thus forms at least partially a female contact, or female connector, for each of the sixteen tools 10 integrated into the interface 100.

In this same example, the body 18 also comprises a first recess 19 sized for receiving the core 12′ of the wire 12, i.e. the conductive portion of the wire 12, for example formed by a set of individual strands. For example, the first recess 19 is arranged according to a second longitudinal end of the body 18, opposite to the first end, as illustrated by FIG. 5.

Thus, according to the example of FIG. 6, the first recess 19 is arranged according to the first face 101 of the interface 100, in opposition with the conductive element 11, so as to receive the 70 mm² wire 12, herein according to the inner portion of the device receiving the interface 100.

In accordance with the underlying concept of the invention, the first recess 19 defines a second axis X2 for receiving the wire 12 oriented according to an acute angle α with respect to the first axis X1. In other words, the two axes X1, X2 define therebetween an angle α corresponding to the orientation of the first recess 19 with respect to the longitudinal direction of the body 18. For example, the orientation of the first recess 19, i.e. the second axis X2, is defined as the axis of revolution of the shape of the first recess 19. In particular, the second axis X2 corresponds to the axis of insertion of the core 12′ of the wire 12 into the first recess 19.

Thus, as illustrated in FIGS. 3 to 7, the wire 12 extends directly from the tool 10 according to the second axis X2, and requires a lesser curvature to deform towards a direction that is not coaxial with X1.

According to this concept, thanks to this angle «, it becomes possible to reduce almost by one half the depth bulk for a section of the wire 12 and an equivalent current flow while complying with the recommendations of minimum radius of curvature of the used wires. Of course, the impact on the bulk depends on the measurement of the angle α and of the final geometry of the wire 12 and of the set-up of the interface 100. According to the example of FIGS. 3 to 7, the angle α is substantially equal to 45°. According to other embodiments, it is provided for an angle α comprised between 30° and 60°, or between 10° and 80°.

It is observed herein that this system for electrical connection via the tool 10 has been retained in order to optimize the volume at the rear portion, i.e. inside, of the interconnection module. In other words, the reduced bulk of the wire 12 assembled with the tool 10 reduces the dimensional constraints of the device to which the interface 100 is integrated.

As illustrated in FIGS. 3 to 5, the tool 10 comprises means for holding the wire 12 in position when the core 12′ is received in the first recess 19, more particularly means 13, 17 for clamping the wire 12 with the body 18. In this case, the clamping means comprise two screws 13, for example ISO 4762 type screws, collaborating with a clamp 17 for clamping the wire 12. It should herein be understood that the selection of the screws 13 is performed so as to limit tooling to standard tools during on-site mounting or maintenance operations, i.e. according to the equipment commonly used in the field of industrial electrical tooling. Hence, this choice involves time and cost savings by limiting the number of references to be kept and by facilitating the operations.

Advantageously, the body 18 has a second recess 16, opening into the first recess 19 and sized so as to receive the clamp 17. Thus, during clamping of the wire 12, the clamp 17 is arranged directly in contact with the core 12′ through the second recess 16 and clamping the wire 12 corresponds to vising the core 12′ between the clamp 17 and the body 18 via the screws 13.

In the example of FIGS. 6 and 7, according to the first face 101 of the interface 100, i.e. inside the interconnection module receiving the interface 100, assembling the wire 12 with the interface 100 corresponds to positioning the 70 mm² wire 12 in the dedicated first recess 19. Afterwards, the wire 12 is held by screwing the clamp 17 also dedicated for this section. It should also be understood that the selection of the screws 13 is preferably performed while taking account of a screwing of the clamps 17 of each tool 10 of the interface 100, without colliding with an adjacent tool 10.

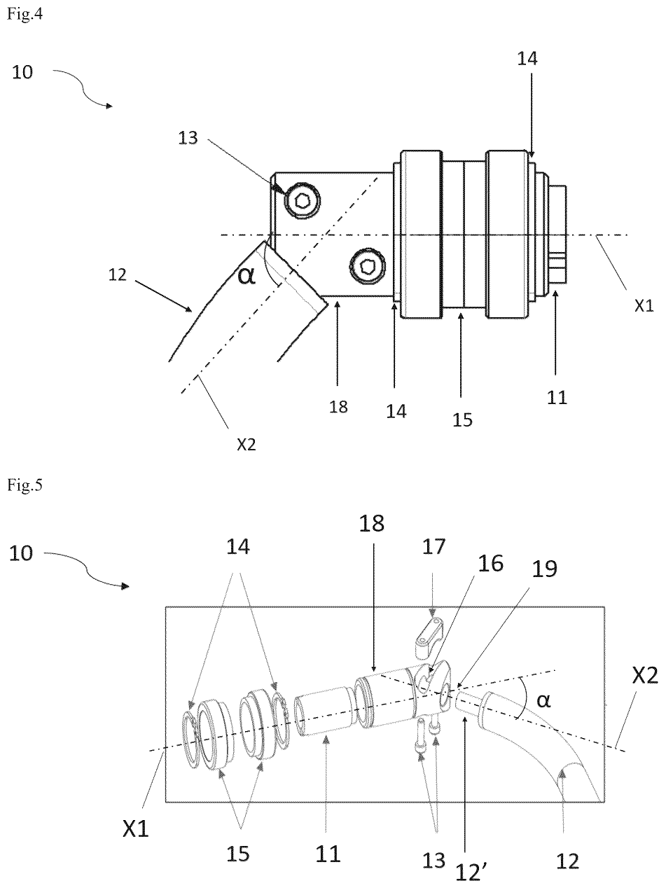

Optionally, the tool 10 also comprises a bushing 15 radially covering the body according to the first axis X1. According to the example of FIGS. 3 and 4, the bushing 15 is thus arranged so as to surround the cylindrical body 18, while releasing the conductive element 11 and the first recess 19. Advantageously, the bushing 15 is made of an electrically-insulating material, i.e. it enables assembly of the tool 10 with other elements, in particular at the interface 100, without establishing electrical contact.

In order to enable simple assembly, a bushing 15 made into two complementary portions as illustrated in FIG. 5 is provided for, interlocking into one another by sliding according to the first axis X1. Afterwards, the socket 15 is held in position around the body 18 via two elastic rings 14, arranged on either side of the bushing 15 and clamped on the body 18 so as to avoid a translation along the first axis X1.

In this example, and as illustrated in FIGS. 6 and 7, assembling the tool 10 on the interface 100, which corresponds for example to a plate made of aluminum, corresponds to mounting the body 18 through an orifice of the interface 100, the two portions of the insulation bushing 15 being arranged on either side of the interface 100, i.e. with a first portion arranged according to the first face 101 and a second portion arranged according to the second face 102, and then interlocked into one another so as to form the bushing 15. The elastic rings 14 are then arranged around the bushing 15, so as to prevent any movement of the bushing 15 relative to the body 18, and by extension any movement of the tool 10 relative to the interface 100.

Optionally, the tool 10 is assembled with the interface 100 so as to enable a rotation of the first recess 19 relative to the first axis X1. Depending on the design, the rotation of the first recess 19 corresponds to a rotation of the tool 10 relative to the interface 100, to a rotation of the first recess 19 relative to the body 18, or to a rotation of the body 18 relative to the bushing 15. This design then allows driving the second axis X2 in rotation relative to the first axis X1, and therefore partially controlling the orientation of the second axis X2, in particular so as to orient the wire 12 according to the desired direction. Thus, this design allows widening all of the positions that could be reached by a given wire 12 assembled with the tool 10, in particular in comparison with a coaxial clamping system of the prior art.

Thus, the present invention relates to an electrical connection tool, as well as a connection interface integrating such a tool, allowing making high-current non-coaxial electrical connections, and thus compatible with the wiring of industrial electrical devices with reduced dimensions without any impediments generated by the radius of curvature of the electrical wires.

It should be observed that this detailed description relates to several particular embodiments of the present invention, yet in no case this description is limiting with regards to the subject-matter of the invention; quite the contrary, it is intended to eliminate any inaccuracy or any wrong interpretation of the following claims.

1. An electrical connection tool ensuring current flow by clamping a core of a wire, said tool comprising:
a body extending according to a longitudinal direction defining a first axis, the body having a conductive element a first recess sized for receiving said core of said wire, the first recess defining a second axis for receiving the core, the second axis being oriented according to an acute angle with respect to the first axis; and
means for clamping said wire with said body such that said tool ensures the current flow between said conductive element and said core of said wire when said core is received by said first recess.

2. The tool according to claim 1, wherein said body further defines two opposite longitudinal ends, said conductive element being arranged according to a first longitudinal end and said first recess being arranged according to a second longitudinal end.

3. The tool according to claim 1, wherein said clamping means comprise a clamp associated with at least one screw.

4. The tool according to claim 3, wherein said body further comprises a second recess opening into said first recess, said second recess being sized for receiving said clamp.

5. The tool according to claim 1, further comprising a bushing made of an insulating material covering said body radially with respect to said first axis, and means for holding said bushing in position according to said first axis.

6. The tool according to claim 5, wherein said bushing includes two portions configured to interlock into one another by sliding according to said first axis.

7. The tool according to claim 5, wherein said position holding means comprise at least one elastic ring arranged adjacent to said bushing according to said first axis.

8. The tool according to claim 1, wherein said conductive element corresponds to a female connector.

9. The tool according to claim 1, wherein said second axis is oriented according to an angle (α) comprised between 10° and 80° with respect to said first axis (X1).

10. The tool according to claim 9, wherein said the acute angle of the second axis is in a range between 30° and 60° with respect to said first axis.

11. The tool according to claim 1, wherein the body and means for clamping are sized so as to ensure said flow of a current of at least 300 A.

12. An electrical connection interface comprising:
a first face;
a second face; and
at least one electrical connection tool according to claim 1, the first recess being arranged according to said first face and the conductive element being arranged according to said second face.

13. The electrical connection interface according to claim 12, wherein said first recess is free to rotate relative to said first axis.

14. An electric panel comprising at least one electrical connection interface according to claim 12.

15. A test bench for a battery cell, said bench comprising at least one electrical connection interface according to claim 12.
